(19) United States
(12) Patent Application Publication
(10) Pub. No.: US 2011/0100503 A1
(43) Pub. Date: May 5, 2011

(54) NO-LEAK LIQUID DISPENSER

(75) Inventors: Chun Yen Wang, El Paso, TX (US); Tony Xiao, Guangdong (CN); Lim Chin Tien, Kuala Lumpur (MY)

(73) Assignee: MTN PRODUCTS, INC., Pomona, CA (US)

(21) Appl. No.: 12/611,221

(22) Filed: Nov. 3, 2009

(51) Int. Cl. B65B 3/04; B67D 1/00

(52) U.S. Cl. 141/18; 222/64

(57) ABSTRACT

A dispensing device capable of no-leak dispensing of a liquid when the dispensing device is in fluid communication with a defective liquid container, including an apparatus enabling the movement of liquid from the liquid container to a holding tank in fluid communication with the liquid container and associated with the dispensing device. The apparatus includes one or more sealing mechanisms which permit ambient air to enter the liquid container through an air path as necessary to enable uninterrupted dispensing, and also permits substantially none of the liquid or only minimal amounts of the liquid to flow out of the holding tank and through the air path, in a no-leak manner, during periods when there is no dispensing.

### BACKGROUND OF THE INVENTION

The present invention generally relates to the dispensing of liquids. More particularly, the invention addresses a pinhole leak problem with water bottles that causes leaks by water dispensing devices.

Referring to FIG. 1, when a good water bottle is used with an appropriate dispensing device (e.g., a water cooler with an appropriate bottle/cooler interface system, such as disclosed in patents referenced below), the air path shown by arrow “X” is the only path for outside air to enter the water bottle, which is necessary to allow replacement of the discharged water space in order to reach pressure equilibrium in the bottle, to enable continue dispensing. If there is a pin hole 11 in water bottle 10 (a not uncommon occurrence), air will enter the bottle through the pin hole instead of through air path “X” because air will travel through the less restricted path. When this occurs, water will continue to flow into tank 12 from bottle 10, and eventually flow out through air path area X.

It would be advantageous to address the pinhole leak problem to avoid leaking water dispensers, in an efficient manner and without interrupting or otherwise compromising dispensing.

### SUMMARY OF THE INVENTION

The objects mentioned above, as well as other objects are solved by the present invention, which overcomes disadvantages of prior dispensing devices and methods, while providing new advantages not believed associated with such devices and methods.

In summary, the present invention provides mechanisms for sealing the air path (“X” in FIG. 1) to prevent water from flowing out when there is an abnormal pressure condition in the tank (such as may be caused by a pinhole leak in the water bottle). The sealing mechanisms provided are not costly and do not interrupt or interfere with dispensing.

More particularly, in a preferred embodiment of the present invention, a dispensing device is provided which capable of no-leak dispensing of a liquid when the dispensing device is in fluid communication with a defective liquid container. The dispensing device includes an apparatus enabling the movement of liquid from the liquid container to a holding tank in fluid communication with the liquid container and associated with the dispensing device. The apparatus preferably includes one or more sealing mechanisms which: a) permit ambient air to enter the liquid container through an air path as necessary to enable uninterrupted dispensing; and b) permit substantially none of the liquid or only minimal amounts of the liquid to flow out of the holding tank and through the air path, in a no-leak manner, during periods when there is no dispensing.

In a preferred embodiment, the one or more sealing mechanisms may include a check valve, and dual gaskets with associated molded, integrated O-rings for air/liquid-tight sealing in the area between the apparatus and the holding tank. A substance, such as silicone grease, may be located in the area between the outer edges of the dual gaskets and the inner surface of the holding tank, for further sealing of the area in a substantially air-tight and liquid-tight manner.

The check valve is in fluid communication with the holding tank, and preferably permits ambient air to enter through the check valve during liquid dispensing, while preventing ambient air from passing through the check valve when liquid is not being dispensed. The check valve may include an elastomeric diaphragm which may be sealed against a sealing surface. Support surfaces, such as one or more blades supported by a post, may be used to support the diaphragm in a position that permits air to pass through spaces between the support surfaces, while also controlling the distance between the diaphragm and the sealing surface.

The check valve is normally closed, and the check valve opens when the liquid within the holding tank drops to a level which causes the cracking pressure of the check valve to be reached, permitting ambient air from outside the dispensing device to travel through the check valve and to enter the liquid container to replace space in the liquid container left by dispensed liquid, enabling uninterrupted dispensing.

The apparatus may include a probe in fluid communication with the liquid container and with the tank, which facilitates the movement of liquid from the liquid container to the tank. One of the sealing mechanisms may also include a probe gasket to air-tight and liquid-tight seal an area adjacent the probe.

### Definition of Claim Terms

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Defective container” means a liquid container, such as but not limited to a water bottle, with one or more cracks and/or pinholes which would normally allow the holding tank to overflow and spill out of the dispensing device, when employed to dispense liquid from a conventional liquid dispensing device such as a conventional water cooler.

“Fluid” includes air, gases and/or liquids, depending on the context, with its broadest meaning intended where otherwise unclear.

“No-leak” or “no-leak manner” mean dispensing systems in which any undesirable leak (i.e., a leak which occurs when dispensing has not been intentionally actuated by a water consumer) from a holding tank of the dispensing unit to an area outside the holding tank, constitutes an insignificant amount of water. By way of example, one water cooler manufacturer set a standard that if no water is drawn from the dispensing unit for 7 days, “no-leak” means that water will not overflow from the cold tank within 7 days. Based on this manufacturer's current design, the amount of water over this time period of 7 days is roughly about 350 ml (12 oz).

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a partial, sectional and perspective view of a “no-leak” water cooler according to a preferred embodiment of the present invention;

FIG. 2 is a sectional view along reference line 2-2 of FIG. 1;

FIG. 3A is a sectional view of the water cooler and water bottle shown in FIG. 1;

FIG. 3B is a sectional view of the circled portion of FIG. 3A, showing the check valve in an open position in which liquid is permitted to flow;

FIG. 3C is a sectional view of the water cooler and water bottle shown in FIG. 1

FIG. 3D is a sectional view of the circled portion of FIG. 3B, showing the check valve in a closed position in which liquid cannot flow through the check valve;

FIG. 4 is an exploded view of the check valve and adjacent parts shown in the circled portion of FIG. 3B;

FIG. 5 is a perspective view of one preferred embodiment of a gasket with an O-ring; and

FIG. 5A is a partial, sectional view of a gasket/O-ring combination.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

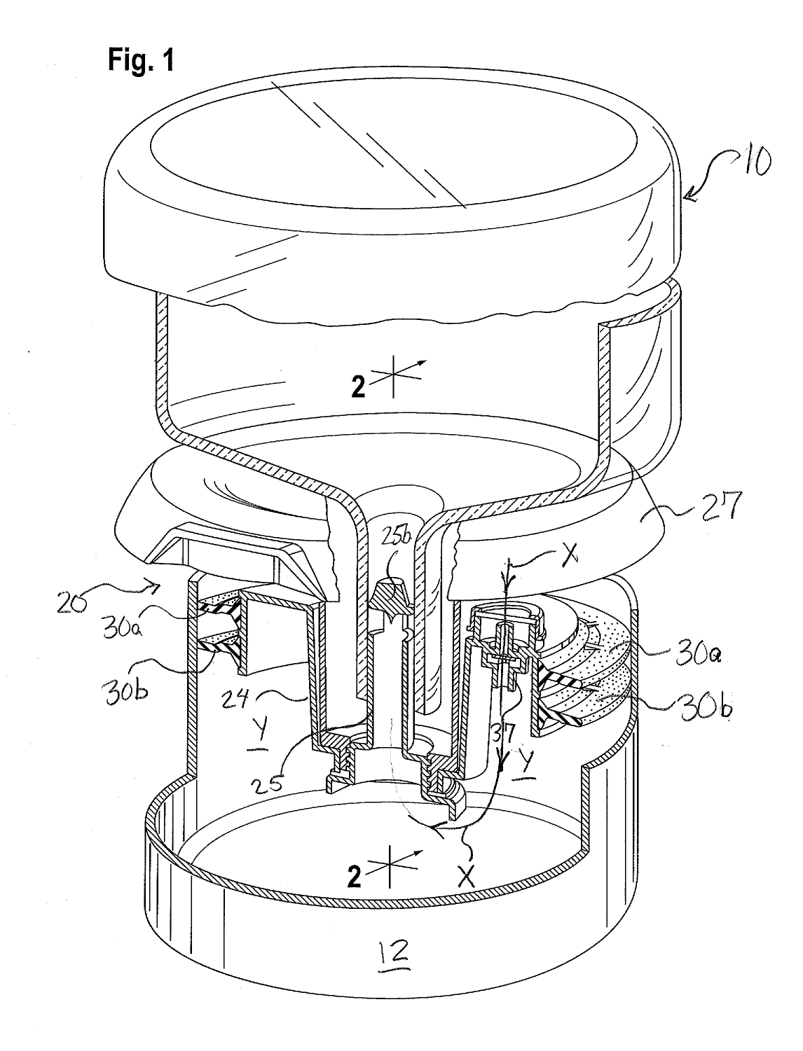

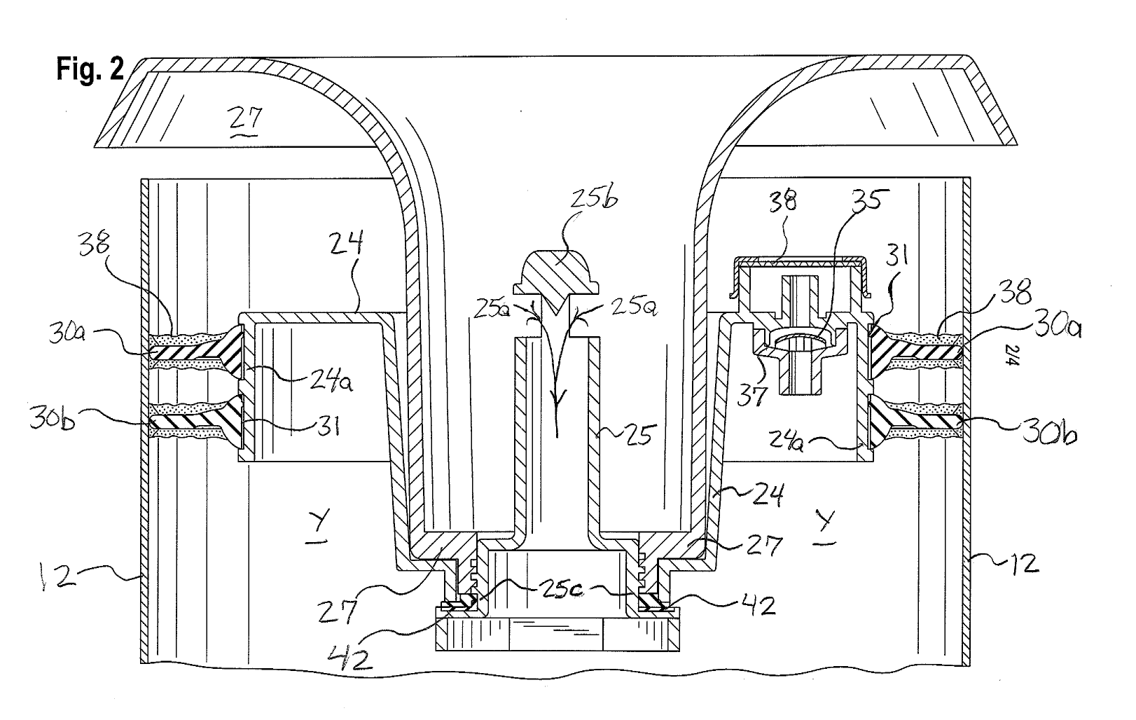

Referring now to FIGS. 1-2, a water cooler interface with a water bottle, generally designated as 20, enables dispensing from the bottle. Interface 20 may be any of a variety of cooler/bottle interfaces, such as but not limited to the interface disclosed in U.S. Pat. Nos. 5,289,854 to Baker, 5,232,125 to Adams, 5,957,316 to Hidding, or co-pending U.S. Ser. No. 11/468,342, filed Aug. 30, 2006, and titled “Liquid Dispensing Apparatus And System” (“the '342 invention”) each of which are incorporated into this disclosure as regarding this interface. With cooler/bottle interfaces of this type, when the water consumer installs a water bottle over interface 20, which may include top cover 27 supported by base 24, an internal cap plug on the bottle cap is dislodged and seats itself on upstanding probe 25 with probe head 25b. (Top cover 27 may be threadably attached to probe 25 at a lower portion of the probe 25c, as shown in FIG. 2.) Openings 25a in the upper portion of probe 25 allow water to flow through the probe and into water cooler holding tank 12, which may be a cold tank. Conventional probes allow air into the bottle, to prevent lock-up during dispensing, using the liquid flow path. The '342 invention probes a probe with dual air/liquid flow path capabilities for this purpose.

Still referring to FIGS. 1-2, in the preferred embodiment of the present invention, interface 20 is specially designed to prevent pinholes in the bottle from causing leaks in the dispensing device. Thus, interface 20 preferably includes various mechanisms for ensuring an air/water tight seal between the ambient atmosphere and the space “Y” between the interface and the water level in the cooler tank. These mechanisms may include one or more of the following, as may be sufficient to obtain the desired no-leak seal: dual ring-shaped gasket pairs 30a and 30b, located on base 24; a molded, integrated O-ring 31 conforming to a distal portion of each gasket 30 to create a tight seal between an outer portion of base 24 and each gasket; an elastomeric diaphragm 35 serving as a check valve and secured by check valve cover 37; an additional probe gasket 42 (located in the area of the threaded connection between lower probe area 25c and the lower portion of top cover 27) to further ensure an air/water tight seal; and silicone grease 38 located between and around gaskets 30a,-30b and cold tank 12, as also shown in FIG. 2. Each of these sealing mechanisms will be further explained below.

Dual gasket pairs 30a and 30b are preferably used, such that any air leak passing through one of the gaskets will not necessarily leak through the second gasket. Gaskets 30a, 30b may be specially molded for this application to fit the diameter on base 24 and cold tank 12.

Referring now to FIGS. 2, 3, 5 and 5A, gaskets 30a, 30b may each be molded with an integrated O-ring 31, which may be specially designed for this application. O-ring 31 may be molded to be part of gaskets 30a, 30b, and preferably ensures a seal between the outer wall 24a of base 24 and a distal end of the corresponding gasket.

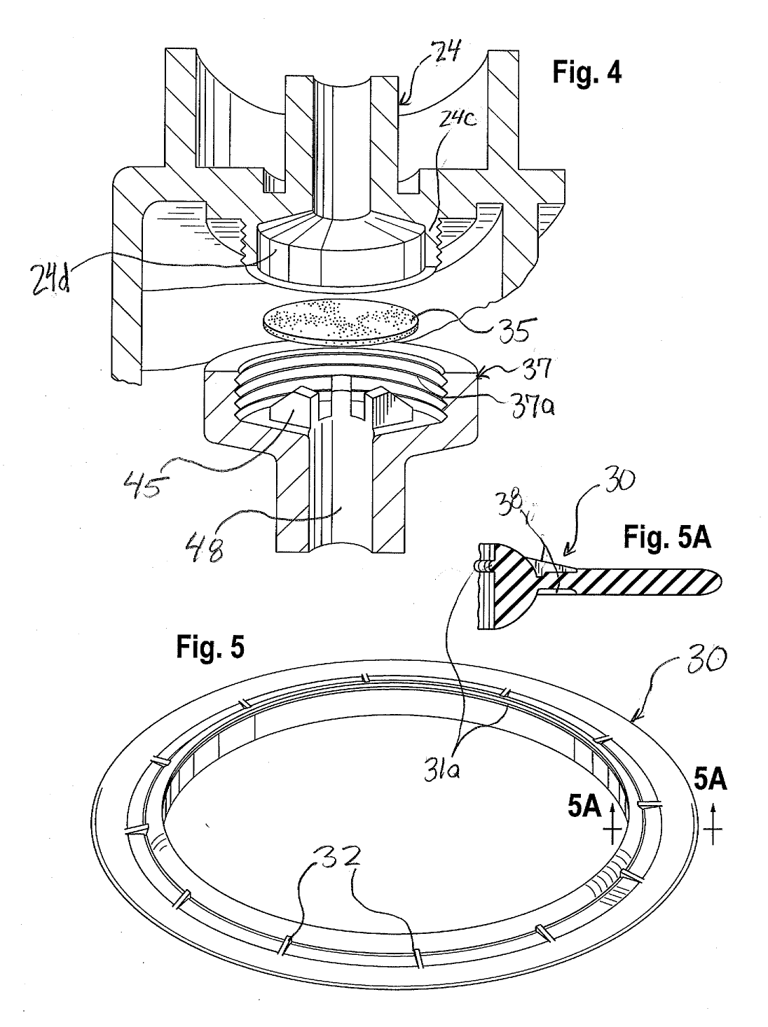

Referring to FIGS. 2 and 5A, a suitable substance, such as silicone grease 38, may be placed between the outside surfaces of each of gaskets 30 and the inner surface of cold tank 12 to ensure that the tank surface quality (especially brushed-type tank surfaces) will not compromise the seal.

Still referring to FIG. 2, probe gasket 42 may be a specially made gasket of an elastomeric material such as silicone rubber, and may be located as shown to ensure that air cannot enter through the probe area.

Sealing every possible area that might leak air from the atmosphere into space Y above the water level in tank 12 ensures that the only available air path is through the area of check valve 35. Referring to FIGS. 2 and 4, base 24 may include check valve cover 37 to hold the check valve diaphragm 35 in location, and filter cover 38 to hold the air filter in location to prevent foreign particles and microbes from traveling through this air path and contaminating the system.

Elastomeric diaphragm 35 is preferably designed to ensure that the check valve will not leak, but will dispense upon demand. Referring to FIG. 4, a cross-sectional view of the check valve area, check valve cover 37 may be threadably connected, for example, to base 24 at a lower base portion. Blades 45 on post 48 are designed to hold elastomeric diaphragm 35 up, so air can pass through the space between blades as needed. Also, blades 45 control the distance between diaphragm 35 and the check valve sealing surface 24d, so that diaphragm 35 is always slightly sealing against the surface 24d, but not pushing onto it so hard as to hinder air from deforming diaphragm 35 and flowing around it during normal water dispensing need. In an alternative embodiment, blade 45 may be made slightly lower, so that diaphragm 35 does not contact sealing surface 24d in the normal water dispensing situation, providing a slightly faster water flow.

When a water bottle with a pinhole is used, the water in the bottle will tend to flow into the cold tank, and the air inside the cold tank will be squeezed and will need to find a path to exit the cold tank. In the preferred design disclosed here in the present invention, the only path is this check valve area. The escaping air creates an air flow which will lift diaphragm 35, causing it to contact sealing surface 24d, and the constant water pressure provided by the bottle will cause the diaphragm to remain sealed.

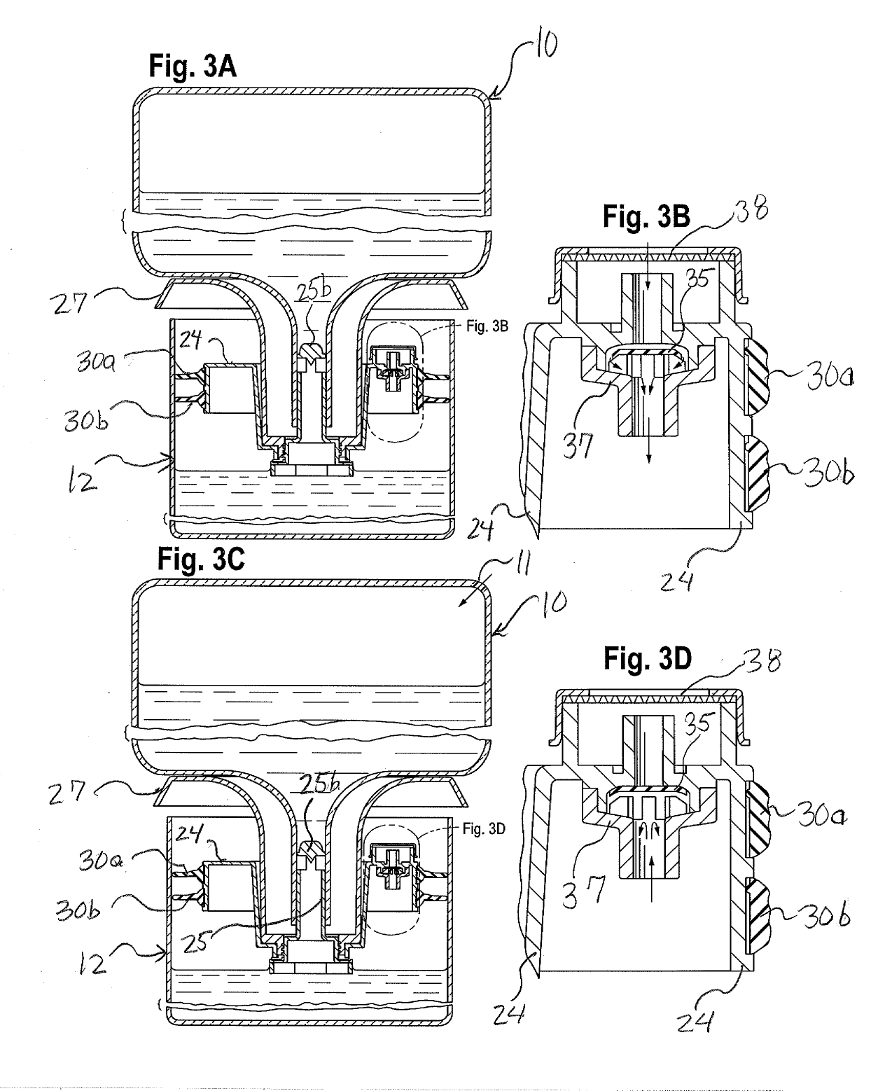

To review, in operation the check valve works as follows. Referring to FIG. 3D, check valve 35 is normally closed, as shown by the arrows indicating water flow. However, when the water in tank 12 drops to a certain level, causing the check valve to reach its cracking pressure, check valve 35 is designed to open (FIG. 3B) and outside air is permitted to travel through the check valve and replace the discharged water space in the bottle. (In this condition, diaphragm/check valve 35 will be pushed down by the greater, atmospheric air pressure, over blades 45 attached to post 48.) When the pressure in the bottle/system reaches equilibrium, the check valve closes, preventing any further passage of air. (The “cracking pressure” of the check valve is the minimum pressure required to open the valve.)

To summarize, referring to FIG. 3C, when a bottle with a pinhole 11 is installed using a conventional dispenser, the air and water in the bottle cannot reach a pressure equilibrium, and water will continue to flow out from the bottle and cause an overflow situation. In contrast, when a bottle is installed using a dispenser equipped with the interface system of the present invention, as all the possible air-leak areas (other than the 1-way check valve) have been sealed, when a user dispenses water from the cooler, the user will not notice that a defective water bottle is involved. Instead, air will still enter the system as needed, and the check valve will close when dispensing is not occurring, to prevent any overflow situation. In fact, the higher the water pressure inside the system, the tighter the cheek valve seal will be.

The above description is not intended to limit the meaning of the words used in the following claims that define the invention. Other systems, methods, features, and advantages of the present invention will be, or will become, apparent to one having ordinary skill in the art upon examination of the foregoing drawings, written description and claims, and persons of ordinary skill in the art will understand that a variety of other designs still falling within the scope of the following claims may be envisioned and used.

It is contemplated that these or other future modifications in structure, function or result will exist that are not substantial changes and that all such insubstantial changes in what is claimed are intended to be covered by the claims.

We claim:

1. A dispensing device capable of no-leak dispensing of a liquid when the dispensing device is in fluid communication with a defective liquid container, comprising:
an apparatus enabling the movement of liquid from the liquid container to a holding tank in fluid communication with the liquid container and associated with the dispensing device, wherein the apparatus comprises one or more sealing mechanisms which:
a. permit ambient air to enter the liquid container through an air path as necessary to enable uninterrupted dispensing; and
b. permit substantially none of the liquid or only minimal amounts of the liquid to flow out of the holding tank and through the air path, in a no-leak manner, during periods when there is no dispensing.

2. The dispensing device of claim 1, wherein the one or more sealing mechanisms comprises a check valve in fluid communication with the holding tank, the check valve permitting ambient air to enter through the check valve during liquid dispensing, and which prevents ambient air from passing through the check valve when liquid is not being dispensed.

3. The dispensing device of claim 2, wherein the check valve comprises an elastomeric diaphragm.

4. The dispensing device of claim 1, wherein the one or more sealing mechanisms comprise dual gaskets for air-tight and liquid-tight sealing of the area between the apparatus and an outside surface of the holding tank.

5. The dispensing device of claim 5, wherein a molded, integrated O-ring is associated with each of the dual gaskets.

6. The dispensing device of claim 1, further including a substance located in the area between the outer edges of the dual gaskets and the inner surface of the holding tank, for sealing the area in a substantially air-tight manner.

7. The dispensing device of claim 6, wherein the substance comprises silicone grease.

8. The dispensing device of claim 1, wherein the apparatus further comprises a probe in fluid communication with the liquid container and with the tank, which facilitates the movement of liquid from the liquid container to the tank, and wherein the one or more sealing mechanisms comprise a probe gasket to air-tight seal an area adjacent the probe.

9. The dispensing device of claim 2, wherein the check valve is normally closed, and the check valve opens when the liquid within the holding tank drops to a level which causes the cracking pressure of the check valve to be reached, permitting ambient air from outside the dispensing device to travel through the check valve and to enter the liquid container to replace space in the liquid container left by dispensed liquid, enabling uninterrupted dispensing.

10. The dispensing device of claim 2, wherein the check valve comprises an elastomeric diaphragm which may be sealed against a sealing surface.

11. The dispensing device of claim 10, further comprising one or more support surfaces for supporting the diaphragm in a position that permits air to pass through spaces between the support surfaces, wherein the support surfaces also control the distance between the diaphragm and the sealing surface.

12. The dispensing device of claim 11, wherein the support surfaces comprise one or more blades.
